(19) United States
(12) Patent Application Publication
(10) Pub. No.: US 2024/0159306 A1
(43) Pub. Date: May 16, 2024

(54) Multi-Slot Gear

(71) Applicant: GM Global Technology Operations LLC, Detroit, MI (US)

(72) Inventors: Cheonjae Bahk, Rochester, MI (US); Bo Li, Troy, MI (US); Dhanasekar Baladhandapani, Koramangala (IN); Pavan Kumar Patruni, Bengaluru (IN); Hung-yih Isaac Du, Rochester Hills, MI (US)

(21) Appl. No.: 18/054,598

(22) Filed: Nov. 11, 2022

(51) Int. Cl. F16H 55/08; F16H 55/17

(52) U.S. Cl. CPC F16H 55/0886; F16H 55/17

(57) ABSTRACT

A multi-slot gear for a powertrain of a vehicle includes an inner ring, an outer ring having gear teeth disposed on a periphery of the outer ring, a web disposed between the inner ring and the outer ring, and a plurality of slots disposed within the web. Each of the plurality of slots includes a slot angle and each of the plurality of slots is separated from one another by a space angle. The ratio of the slot angle to the space angle is greater than two.

### INTRODUCTION

The present disclosure relates to a multi-slot gear blank. More particularly, the present disclosure relates to a multi-slot gear blank optimized for high performance applications having reduced noise, vibration, handling (NVH) and reduced mass.

NVH and light weighting of gears have become more important engineering challenges for electrical vehicle programs. For example, reduced NVH is important with quitter electric motors while reduced weight improves vehicle battery range. In particular, transfer gears located between motors and drive shafts may have NVH issues, such as noise, due to the high torque that is applied to the transfer gear. One solution is to use additional components, such as an acoustic blanket surrounding the transfer gear, to reduce noise issues. While effective, there is a need in the art for improved gear designs that include slots to reduce local stress concentration, which enables the design to be used in high performance applications where high torque is applied, while also reducing NVH and reducing gear weight.

### SUMMARY

A multi-slot gear for a powertrain of a vehicle is provided. The multi-slot gear includes an inner ring, an outer ring having gear teeth disposed on a periphery of the outer ring, a web disposed between the inner ring and the outer ring, and a plurality of slots disposed within the web. Each of the plurality of slots includes a slot angle and each of the plurality of slots is separated from one another by a space angle. The ratio of the slot angle to the space angle is greater than 2.

In one aspect, the plurality of slots includes more than four slots.

In another aspect, the plurality of slots includes eight slots.

In another aspect, the slot angle is 34 degrees.

In another aspect, the space angle is 11 degrees.

In another aspect, the slot angle is defined as a radial angle measured relative to an axis, about which the inner ring and the outer ring are coaxial, from one end of one of the plurality of slots to another end of the one of the plurality of slots.

In another aspect, the space angle is defined as a radial angle measured relative to the axis from the one end of the one of the plurality of slots to a nearest end of an adjacent one of the plurality of slots.

In another aspect, the web has a web thickness, measured along an axis of the multi-slot gear, less than a thickness of the inner ring and a thickness of the outer ring.

In another aspect, the plurality of slots are each defined as portions of the web with no material that extends completely through the web.

In another aspect, each of the plurality of slots are identical and disposed symmetrically about an axis of the multi-slot gear.

In another aspect, the plurality of slots each have a slot width, measured in a radial direction from an axis of the multi-slot gear, that is less than a web width of the web, measured in the radial direction from the axis.

In another aspect, each of the plurality of slots include semi-circular ends.

In another aspect, each of the plurality of slots is arcuate.

According to another embodiment, a multi-slot gear for a powertrain of a vehicle is provided. The multi-slot gear includes an inner ring, an outer ring having gear teeth disposed on a periphery of the outer ring, a web disposed between the inner ring and the outer ring, and a plurality of slots disposed within the web. Each of the plurality of slots includes a slot angle. Each of the plurality of slots is separated from one another by a space angle. The ratio of the slot angle to the space angle is greater than 2 and less than 5, and the plurality of slots includes more than four slots.

In one aspect, the plurality of slots includes eight slots.

In another aspect, the slot angle is defined as a radial angle measured relative to an axis, about which the inner ring and the outer ring are coaxial, from one end of one of the plurality of slots to another end of the one of the plurality of slots.

In another aspect, the space angle is defined as a radial angle measured relative to the axis from the one end of the one of the plurality of slots to a nearest end of an adjacent one of the plurality of slots.

In another aspect, the web has a web thickness, measured along an axis of the multi-slot gear, less than a thickness of the inner ring and a thickness of the outer ring.

In another aspect, the plurality of slots each have a slot width, measured in a radial direction from an axis of the multi-slot gear, that is less than a web width of the web, measured in the radial direction from the axis.

According to another embodiment of the present disclosure, a powertrain for a vehicle is provided. The powertrain includes a motor having an output shaft, an output gear disposed on the output shaft, a transfer shaft, and a multi-slot gear disposed on the transfer shaft and in mesh with the output gear. The multi-slot gear includes an inner ring, an outer ring having gear teeth disposed on a periphery of the outer ring, a web disposed between the inner ring and the outer ring, and a plurality of slots disposed within the web, wherein each of the plurality of slots includes a slot angle, and wherein each of the plurality of slots is separated from one another by a space angle, wherein the ratio of the slot angle to the space angle is greater than 2. The powertrain further includes a transfer gear disposed for co-rotation on the transfer shaft, a driveshaft, and a driven gear disposed on the driveshaft and in mesh with the transfer gear, wherein output torque from the motor is transferred from the output shaft and the output gear to the multi-slot gear, the multi-slot gear rotates the transfer shaft and the transfer gear to transfer torque to the driven gear and the driveshaft.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an exemplary powertrain having a multi-slot gear according to the principles of the present disclosure;

FIG. 2 is an embodiment of the multi-slot gear;

FIG. 3 is a graph illustrating a relationship between a ratio and number of slots in a multi-slot gear; and

FIG. 4 is a graph illustrating a relationship between number of slots and reduced mass and reduced stress in a multi-slot gear.

### DETAILED DESCRIPTION

The following description is merely exemplary in nature and is not intended to limit the present disclosure, application, or uses.

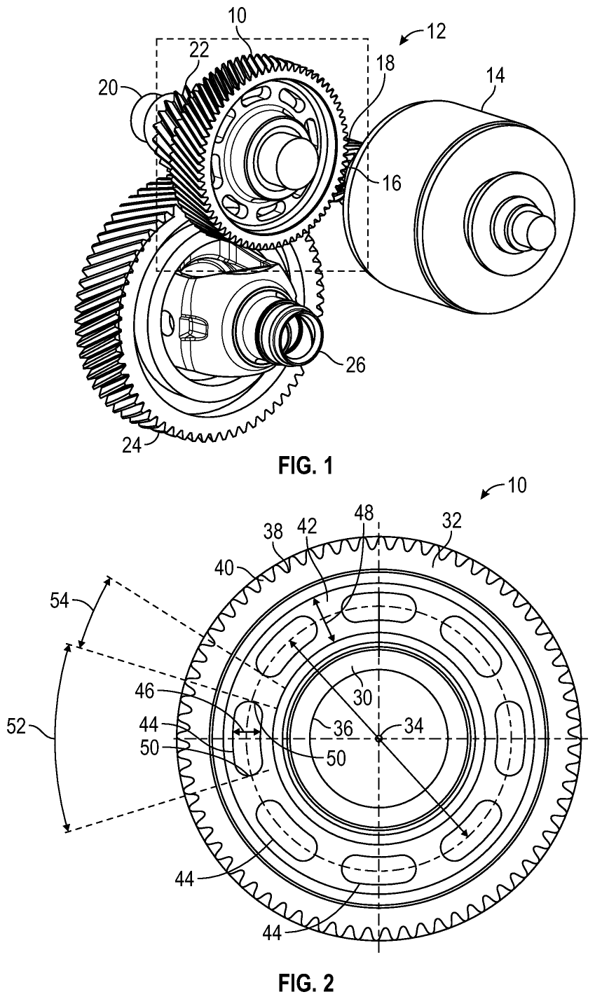

Referring to FIG. 1, a multi-slot gear 10 according to the principles of the present disclosure is shown with an exemplary powertrain 12. The powertrain 12 is used in a vehicle (not shown) and generally includes a motor 14 having an output shaft 16. An output gear 18 is disposed on the output shaft 16. The output gear 18 is in mesh with the multi-slot gear 10. The multi-slot gear 10 is disposed for co-rotation on a transfer shaft 20. A transfer gear 22 is also disposed for co-rotation on the transfer shaft 20. The transfer gear 22 is in mesh with a driven gear 24. The driven gear 24 is disposed on a driveshaft 26 which connects with drive wheels (not shown). Output torque from the motor 14 is transferred from the output shaft 16 and the output gear 18 to the multi-slot gear 10. The multi-slot gear 10 rotates the transfer shaft 20 and the transfer gear 22, thus transferring torque to the driven gear 24 and the driveshaft 26. Due to the diameter and tooth count of the multi-slot gear 10 relative to the output gear 18, the multi-slot gear 10 is subjected to high amounts of torque during operation of the powertrain 12.

The multi-slot gear 10 is designed using multibody dynamic analysis to determine the most influential parameters to NVH, stress, and light-weighting. First, a time varying mesh stiffness of the multi-slot gear 10 is calculated using system modelling of shafts, bearings gears, as well as geometric and kinematic boundary conditions. Multibody dynamic analysis includes identifying the flexible bodies in the system (housing, shafts, stators), time varying mesh stiffness from the previously performed system modeling, and running a simulation to determine vibration responses, forces, etc. Then, an acoustic analysis is performed to determine if noise is reduced using the multi-slot gear design.

Turing to FIG. 2, the multi-slot gear 10 designed according to the principles of the present disclosure is illustrated in greater detail. The multi-slot gear 10 is generally defined by a plurality of design parameters described below. The multi-slot gear 10 includes an inner ring 30 and an outer ring 32 disposed about an axis 34. The inner ring 30 defines a bore 36 through which the transfer shaft 20 (FIG. 1) is disposed. The outer ring 32 includes a peripheral diameter 38 that defines a plurality of gear teeth 40. The gear teeth 40 are sized to mesh with the output gear 18 (FIG. 1). A web 42 extends between the inner ring 30 and the outer ring 32. The web 42 has a web thickness (measured along the axis 34) less than a thickness of the inner ring 30 and a thickness of the outer ring 32.

A plurality of slots 44 are disposed through the web 42. The slots 44 are defined as portions of the web 42 with no material that extend completely through the web 42 of the multi-slot gear 10. Each of the slots 44 are identical and disposed symmetrically about the axis 34. The slots 44 each have a slot width 46, measured in a radial direction from the axis 34. The slot width 46 is less than a web width 48, measured in the radial direction from the axis 34. Each of the slots 44 is arcuate with ends 50. In one non-limiting aspect, the ends 50 are each semi-circular, though other shapes may be employed. and is defined by a slot angle 52. The slot angle 52 is defined as a radial angle measured relative to the axis 34 from one end 50 of one slot 44 to another end 50 of the one slot 44. The distance between adjacent slots 44 is defined by a space angle 54. The space angle 54 is defined as a radial angle measured relative to the axis 34 from one end 50 of one slot 44 to the nearest end 50 of an adjacent slot 44.

To design a transfer gear that meets the requirements of mass, stress, and NVH, each of the parameters of the transfer gear must be adjusted and a near infinite number of combinations is possible, making optimization of the transfer gear difficult. However, the number of slots 44 and the position/size of the slots 44 relative to the web 42 have been determined using the principles of the present disclosure as the primary parameters in reducing mass, stress, and NVH issues. Accordingly, to reduce NVH issues, reduce mass, and reduce stress, a ratio of the slot angle 52 to the space angle 54 is greater than 2 for the multi-slot gear 10. In addition, the plurality of slots 44 includes more than four slots. In one embodiment, the plurality of slots 44 includes eight slots where the slot angle 52 is approximately 34 degrees and the space angle 54 is approximately 11 degrees. It should be appreciated that the term “approximately” is known to those skilled in the art. Alternatively, the term “approximately” is defined as +/−4 degrees.

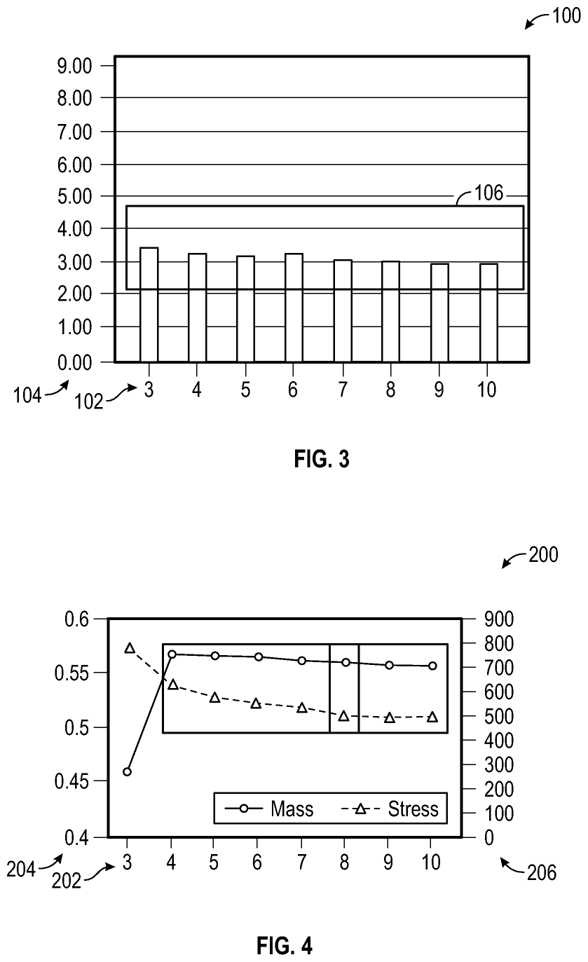

FIG. 3 illustrates a graph 100 showing a relationship between the ratio of the slot angle 52 and the space angle 54 to the number of slots 44. The x-axis 102 represents the number of slots 44. The y-axis is the ratio of the slot angle 52 and the space angle 54 to the number of slots 44. The other parameters of the transfer gear, including web width, is held constant for each number of slots 44. The graph 100 is prepared by the method described above including multibody dynamic analysis using time varying mesh stiffness to minimize local stress concentrations in the web 42 while maximizing NVH reduction and mass reduction. A box 106 illustrates the effective NVH area for each of the number of slots 44. The effective NVH area 106 represents multi-slot gear 10 designs meeting the NVH requirements of the powertrain 12. The ratio of the slot angle 52 to the space angle 54 falls within the effective NVH area 106 when the ratio is greater than 2. In one aspect, the ratio is preferably less than 5 to fall within the effective NVH area 106.

FIG. 4 illustrates a graph 200 showing a relationship between the number of slots 44 in a design for the multi-slot gear 10 and a reduced mass and stress. The x-axis 202 represents the number of slots 44. The y-axis 204 represents a reduced mass in kg. The reduced mass is relative to a gear design having no slots. The y-axis 206 represents the stress in the web 42 in MPa.

With reference to FIGS. 3 and 4, it can be determined that in order to optimize for NVH, the ratio of the slot angle 52 to the space angle 54 is greater than 2 for the multi-slot gear 10. In addition, it can be determined that in order to optimize for reduced mass and reduced stress, the plurality of slots 44 includes more than four slots and optimally the plurality of slots 44 includes eight slots.

The multi-slot gear 10 described and optimized as described above provides many advantages over conventional designs. By reducing NVH, the multi-slot gear 10 can be used in high torque applications in electric vehicle programs. By reducing mass while minimizing stress, the multi-slot gear 10 improves vehicle efficiency and range.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1.-13. (canceled)

14. A multi-slot gear for a powertrain of a vehicle, the multi-slot gear comprising:
an inner ring;
an outer ring having gear teeth disposed on a periphery of the outer ring;
a web disposed between the inner ring and the outer ring; and
a plurality of slots disposed within the web, wherein each of the plurality of slots includes a slot angle, and wherein each of the plurality of slots is separated from one another by a space angle,
wherein a ratio of the slot angle to the space angle is three to one, and wherein the plurality of slots includes more than four slots.

15. The multi-slot gear of claim 14, wherein the plurality of slots includes eight slots.

16. The multi-slot gear of claim 14, wherein the slot angle is defined as a radial angle measured relative to an axis, about which the inner ring and the outer ring are coaxial, from one end of one of the plurality of slots to another end of the one of the plurality of slots.

17. The multi-slot gear of claim 16, wherein the space angle is defined as a radial angle measured relative to the axis from the one end of the one of the plurality of slots to a nearest end of an adjacent one of the plurality of slots.

18. The multi-slot gear of claim 17, wherein the web has a web thickness, measured along an axis of the multi-slot gear, less than a thickness of the inner ring and a thickness of the outer ring.

19. The multi-slot gear of claim 18, wherein the plurality of slots each have a slot width, measured in a radial direction from an axis of the multi-slot gear, that is less than a web width of the web, measured in the radial direction from the axis.

20. A powertrain for a vehicle comprising:
a motor having an output shaft;
an output gear disposed on the output shaft;
a transfer shaft;
a multi-slot gear disposed on the transfer shaft and in mesh with the output gear, the multi-slot gear comprising:
an inner ring;
an outer ring having gear teeth disposed on a periphery of the outer ring;
a web disposed between the inner ring and the outer ring; and
a plurality of slots disposed within the web, wherein each of the plurality of slots includes a slot angle, and wherein each of the plurality of slots is separated from one another by a space angle,
wherein the slot angle is approximately 34 degrees and the space angle is approximately 11 degrees;
a transfer gear disposed for co-rotation on the transfer shaft;
a driveshaft; and
a driven gear disposed on the driveshaft and in mesh with the transfer gear,
wherein output torque from the motor is transferred from the output shaft and the output gear to the multi-slot gear, the multi-slot gear rotates the transfer shaft and the transfer gear to transfer torque to the driven gear and the driveshaft.
